(19) United States
(12) Patent Application Publication
(10) Pub. No.: US 2005/0177404 A1
(43) Pub. Date: Aug. 11, 2005

(54) Device and a method for using an enhanced high priority calendar event

(76) Inventor: Tarmo Hyttinen, Liimattala (FI)

Correspondence Address: Ware, Fressola, Van Der Sluys & Adolphson, LLP;Building Five, Bradford Green, 755 Main Street, P.O. Box 224, Monroe, CT, 06468, US

(21) Appl. No.: 10/775,545

(22) Filed: Feb. 10, 2004

(51) Int. Cl. G06F 17/60

(52) U.S. Cl. 705/7

(57) ABSTRACT

The invention relates to an enhanced high priority event of a calendar application. The invention also relates to a method for using an enhanced high priority calendar event. A device for handling a calendar application comprises means for browsing a calendar application; means for receiving a high priority event; means for searching possible overlapping events in a calendar application, as a response to receiving a high priority event; means for presenting found one or more overlapping events; means for receiving instructions for processing certain one or more presented overlapping events; and means for processing overlapping events according to received instructions.

### TECHNICAL FIELD

The invention relates to an enhanced high priority event of a digital calendar application. The invention also relates to a method for using an enhanced high priority calendar event.

### BACKGROUND OF THE INVENTION

Digital calendar applications are commonly used. Calendar applications can be used by a computer having an application for browsing and using the application. Digital calendar applications can also be used over an airway by a wireless device or by a fixed device. A device having remote access to a calendar application must have an application for using the calendar or a browser for accessing a remote calendar application.

Calendar applications can include different kind of events. Typically calendars are used for keeping records and reminding a user of important events. Calendars record events inserted therein and times connected to events. The recorded events can be meetings, reminders, events or happenings that are to be reminded on certain time. A calendar has typically reminders or events, which are reminded periodically. For example a birthday is typically recorded for the same day every year. Another example is a weekly meeting, which occurs at the same time every week and is thus regularly scheduled on the calendar.

Different kinds of events can be indicated in separate ways to identify events from each other. For example phone calls, birthdays, meetings, reminders and other events have different icons, which are displayed in the calendar with the event. Another way to differentiate events is to display them in different colors or tones. The calendar can thus be glanced at and certain kinds of events can be found immediately. This makes the calendar fast, easy and convenient to use.

Calendar applications used in a certain local area network or being otherwise connectable or accessible by other calendar applications, can communicate with each other. Users may send for example notices, calls or invitations from their calendar application to other users through their calendar application. A typical situation is that someone wants to set up a meeting by sending an invitation to chosen participants. Firstly a sender formulates a message, or an invitation and secondly the sender chooses certain receivers, e.g. participants. The sender can typically see the calendar of a chosen receiver to some extent. Usually the sender gets knowledge of busy or booked times and free times of a receiver's calendar. Typically these are not revealed in detail to outside observers, but other users having access to certain calendar applications, can observe possible free times of calendars. Free and booked times are commonly indicated by different icons, colours, tone values, visual effects or texts. For example booked time can be indicated by red text and reserved, but not yet confirmed times by a text having lighter red tone.

A user of a calendar handles the application and accepts, confirms or rejects the suggestions sent to his calendar. The user of a calendar application can add, remove, delete and arrange events of his calendar. The possible overlapping events are handled, i.e. removed, changed, silenced or re-arranged by the user. The overlapping situations are handled so that first any overlapping events are manually searched by the user from his calendar. After an overlapping event is fetched, the user must decide what to do with it and perform defined acts. After this the next overlapping event is searched. The whole time range of a new event has to be checked, and overlapping events searched and processed one by one. This might be disturbing, especially if there is a long period during which the user will not be available for agreed meetings and events. This kind of situation can occur for example if the user spends a long period abroad or suffers from sickness being thus unable to attend appointed meetings and events. Somehow the user must always handle an overlapping situation in the calendar, meaning a situation in which two different events are supposed to exist at least partly at the same time. Usually it is advantageous at least to silence another meeting not to make alarms during the other one. This kind of handling of all overlapping messages can be very time consuming. Further there is always a possibility that the user does not notice some important data in his calendar. The not noticed overlapping data may mistakenly be left as overlapping, and thus not silenced, removed or rescheduled in time. It can be crucial to miss important events. Also it is disturbing, if an alarm reminding the user of another event is performed during a meeting.

### THE OBJECTIVE OF THE INVENTION

An objective of the present invention is to overcome the drawbacks of the prior art solutions. Another objective of the present invention is to enhance and ease the use of calendar applications. A further objective of the present invention is to diversify use and usability of a calendar application.

The objectives are achieved by producing an enhanced calendar event having high priority over other events. Further the objectives are achieved by an enhanced high priority calendar event, which automatizes the handling of overlapping messages.

The enhanced calendar event according to an embodiment of the invention is determined to be any kind of calendar event having high priority in the calendar application. A high priority event according to an embodiment is fed to a calendar application for adding a high priority event to a calendar. As a response to receiving a high priority calendar event to the calendar application, there is searched possible overlapping events in a calendar application. When one or more overlapping events are found, they are presented with one or more processing alternatives for processing the found events. Processing alternatives may include for example silencing or removing overlapping events. Typically the user inputs the instructions for processing the overlapping events. According to an embodiment overlapping events are then processed according to one or more received processing selections. According to one embodiment overlapping events can be saved for possible subsequent recovery or recheck of calendar events.

According to an embodiment of the invention overlapping events are searched as a response to receiving a high priority event. If overlapping notations, markings, recordings or any kind of events exist in a calendar application, they are presented to a user. The user is also able to define how he wants to process found overlapping events. According to one embodiment the user may silence, delete or remove overlapping events existing in the calendar application. For example the user can enter a vacation period to his calendar application, and determine it as a high priority event. Any overlapping events can be removed according to an embodiment of the invention and cancelled or rescheduled to a convenient time. Some overlapping events, such as birthdays, may be left untouched in the calendar during holidays. If a determined high priority event is a meeting, an overlapping birthday event may be silenced. This way a birthday event will not disturb the meeting by a voice alarm, but it is still in the calendar for reminding the user. Another practical example of a high priority event is a certain period abroad to be added to a calendar. In this case it may be wished that overlapping birthday marks be left in the calendar as reminders, an overlapping weekly meeting may be deleted, but certain telephone negotiations may be left, since those are not dependent on the place, but can be handled anywhere a telephone connection can be established.

According to an embodiment of the present invention possible overlapping events are automatically searched in response to receiving a high priority event. According to another embodiment a high priority event is formed by a device receiving it to its calendar application. According to yet another embodiment a high priority event is sent by another device. So, a user of a device may formulate a high priority event for his own calendar application, or user may receive a high priority event, such as a call for a meeting, from some other device. The automatic handling of overlapping events is advantageous, since any user mistakes are avoided in searching overlapping events and a user is at least made aware of all overlapping events. Additionally if a high priority event covers a long period of time, there is advantageously presented a selection for removing or silencing all overlapping events. This makes it easy and fast to clear a calendar from all events, for example when changing duties, or being released from former ones marked in a calendar, or if having a long vacation. Typically a high priority event needs to be confirmed by a user before it can be added to a calendar application.

### BRIEF DESCRIPTION OF THE DRAWINGS

The invention is described in detail with the accompanying drawings. The drawings illustrate the invention by way of an example only. The drawings are not to be interpreted as limiting, but rather as illustrative embodiments of the present invention.

FIG. 1 illustrates a method according to an embodiment of the present invention;

FIG. 2 illustrates a method according to an embodiment of the present invention;

FIG. 3 illustrates a selection window according to an embodiment of the present invention; and

FIG. 4 illustrates a device according to an embodiment of the present invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized, and structural and functional modifications may be made without departing from the scope of the present invention. It should also be understood that the embodiments shown may be carried out by various combinations of hardware, software, firmware or any desired combination thereof.

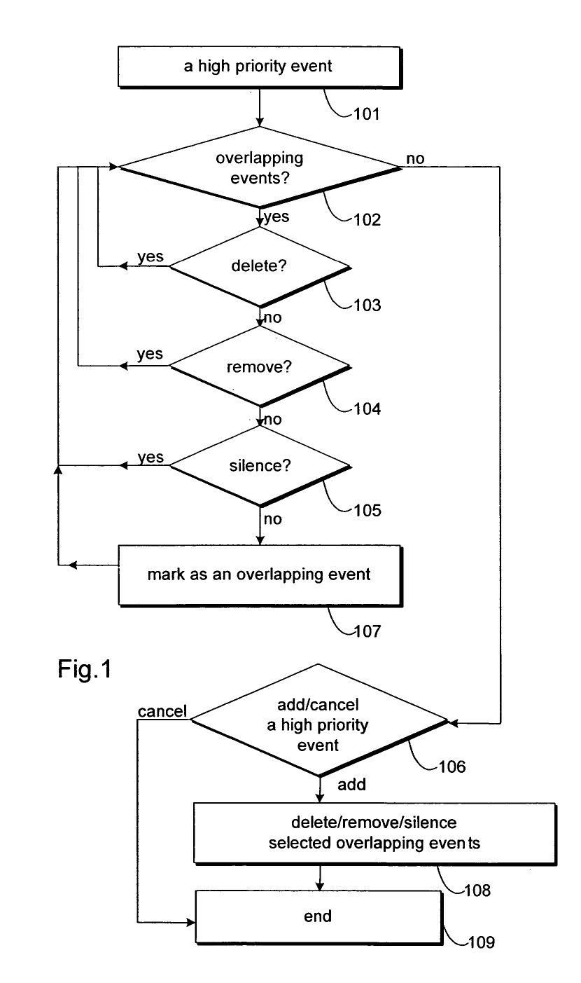

FIG. 1 illustrates a method for adding an enhanced high priority event to a calendar application. According to the illustrated embodiment a high priority event to be added in a calendar application is formed by a user and received by a calendar application in a phase 101. A high priority event is typically a remark, a meeting, a reminder, a notation, a marking or other recording of the calendar application associated with the time information. Associated time can be a certain exact alarm time, a period of time or an estimated time range. Any type of event can be classified having high priority according to an embodiment of the present invention. According to one embodiment a high priority event is one choice of the menu including different calendar events. According to another embodiment any calendar event existing in the menu can be classified to have high priority by marking the calendar event in question. This way different kind of basic events can be classified having high priority over the other events.

In phase 102 there is automatically searched, whether there exist any overlapping events during a time range determined for a high priority event, which is to be added in the calendar application in phase 101. If no other marking exists in the calendar application during the time range of the high priority event according to the embodiment, the execution proceeds to phase 106, in which a user can either cancel or confirm the adding of the high priority event, formulated in phase 101. If the high priority event is cancelled at phase 106, execution ends at phase 109 and the high priority event received in phase 101 is deleted. If the high priority event is chosen to be added in phase 106, execution proceeds to phase 108. In phase 108 the overlapping events the user has chosen to delete, remove or silence in phases 103-105, are processed according to instructions received by the user and then execution is ended in phase 109.

If there exists an overlapping event, i.e. another marking in the calendar application during the time range of the high priority event according to the embodiment, in phase 102, the execution proceeds to phase 103. In phase 103 the user can choose, whether he wants to delete the found overlapping event. Typically there is also a one-touch selection for deleting all the overlapping events (not illustrated in FIG. 1). By this selection user can delete all possible overlapping events by one command and there is no need for checking all events separately. This kind of deletion is advantageous for example if the user is absolutely unavailable for a certain period. If all the overlapping events are chosen to be deleted, the execution proceeds to phase 106, where the user can either cancel or add the high priority event. If one overlapping event is deleted, the execution proceeds according to phase 102 by checking whether there are further overlapping events. If no deletion is made in phase 103, the execution proceeds to phase 104, where an overlapping event can be removed.

According to one embodiment there is also a selection for removing all overlapping events at once in phase 104 (not illustrated in FIG. 1). If a user chooses to remove all, no separate selections are needed, but all overlapping events are removed by one command. After removing all, the execution proceeds to phase 106, where it is confirmed, i.e. the high priority event is either added to a calendar or cancelled. If the high priority event is cancelled at phase 106, no user selections made in earlier phases are performed. If the presented overlapping event is chosen to be removed in phase 104, the execution proceeds to phase 102 and the next overlapping event is searched. If the user does not want to remove the suggested overlapping event in phase 104, the execution proceeds to phase 105, in which the user can silence the overlapping event. If the suggested presented event is chosen to be silenced in phase 105, the execution proceeds to phase 102 and to check other possible overlapping events. If the overlapping event is not chosen to be deleted in phase 102, removed in phase 104 or silenced in phase 105, it can be just marked as an overlapping event according to phase 107. This marking can be done by lightening a colour or a tone of the event in the calendar. Another possibility for marking an overlapping event is to make it easily recognizable by some marking preceding or surrounding it, such as *event*, [symbol] event, (event). Typically these kind of overlapping markings are used at an early stage, when events are not finally confirmed. This way overlapping events and meetings are easily seen later. Especially if later the high priority event is cancelled, the overlapping one(s) remain in the calendar application at their own places and cancelled times are not mistakenly marked as free. Commonly the overlapping events, which are classified to be less important than a high priority event according to an embodiment, are at least silenced.

According to one embodiment a delete command removes events from the calendar to some memory area from which events can be later recovered. Saved removed events can be recovered for example if a high priority event, which took a calendar place of a removed event, is later deleted or removed. According to one embodiment such recovery, after a high priority event is deleted or removed, is done automatically. As a response of removing a high priority event a memory area including removed events is searched for events associated within a time range associated to the high priority event to be removed now. If found, the earlier removed, overlapping events can be returned to a calendar application to their original places, according to time information associated with them. Deletion of an event can be determined to be final so that deleted events are not recoverable.

According to an embodiment an overlapping event can be removed to some predetermined memory area, which can be allocated from an existing memory block or be a separate memory unit. Overlapping events can be saved in a memory block for a predetermined period, or for example until a time or a time range associated to them is passed. According to an embodiment removed events are saved until the time information associated to them is passed. After the associated time or time range is fully passed removed events are deleted from the memory block and cannot be recovered any more. According to another embodiment removed events are saved to memory having certain space, i.e. being able to save certain number of events. This embodiment saves removed events sequentially and when the memory block is full, the next removed event is saved in the place of the first saved event and the first one saved is deleted. Also other kinds of constructions and functions can be utilized for implementing the saving of overlapping events according to an embodiment of the invention.

According to one embodiment a user can formulate a high priority event by selecting it from a menu of a calendar application of his device. A high priority event selected form a menu can have a selectable field for choosing a destiny of all possible overlapping messages. This field could define that all overlapping calendar events are to be silenced, removed or deleted. This kind of embodiment makes for example a cleaning or emptying of a calendar very fast and easy.

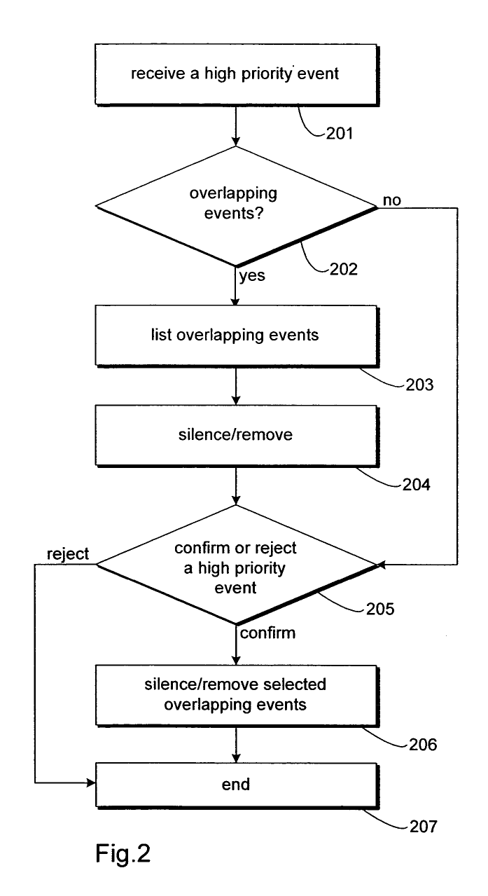

In FIG. 2 a high priority event is received to the device in phase 201. The calendar applications can communicate with each other and FIG. 2 illustrates a method for receiving a high priority event sent by another device. The device can be any device able to browse a digital calendar application. After a high priority event is received in phase 201, overlapping events are searched in phase 202. If no event is found to be scheduled to a time range of a received high priority message, the execution proceeds according to phase 205. In phase 205 user can either confirm the received high priority event and accept it to be added to his calendar, or reject the received high priority event, thus deleting it. If the high priority event is rejected in phase 205, the execution ends at phase 207. If the high priority event is confirmed in phase 205, user selections made, relating to processing of overlapping events, are performed in phase 206 and then the execution is ended at phase 207.

If overlapping events are found in phase 202, execution proceeds to phase 203 in which the found overlapping events are listed and displayed to a user. Overlapping events are listed for presenting one or more overlapping events with one or more processing alternatives for processing the found events. The user inputs his instructions for processing overlapping events in phase 204, for example by selecting which ones he wants to silence, which ones to remove. After selecting the ones to remove and the ones to save in their places in calendar, but be silenced, the user typically gives an indication that all is accomplished, e.g. by pressing an ok-button, and the execution can move on to next phase 205. In phase 205 the user can accept the received high priority event and place it in his calendar, or he may still choose to reject the high priority event. If the received high priority event is rejected, it will be deleted and the original events, silenced or removed in phase 204 are kept in their original places at their original form, so no removal or silencing is accomplished. The execution ends at phase 207. If the received high priority event is confirmed by a user in phase 205, the overlapped events selected by the user are processed according to instructions received by the user in phase 206. After the high priority event is added to a calendar application and the overlapping events are processed, execution ends at phase 207.

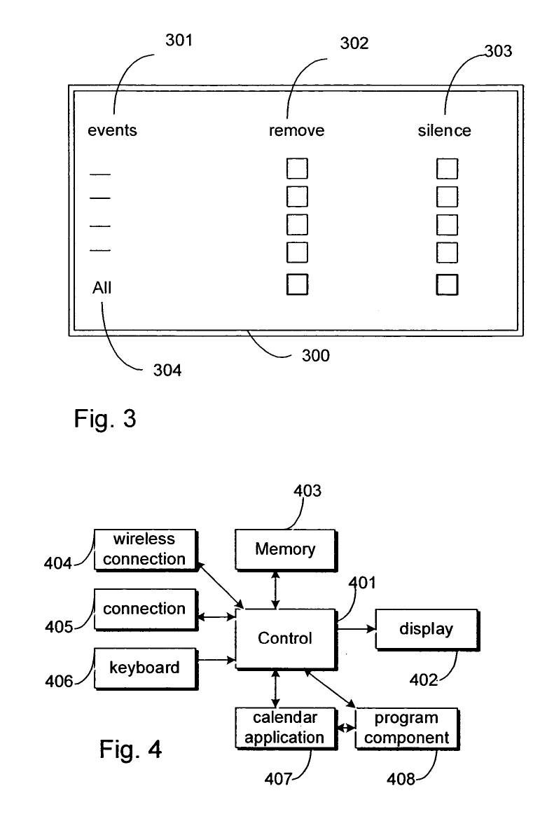

Typically in phase 203 of FIG. 2 all overlapping events are listed. One typical way to present the overlapping events to user is illustrated in FIG. 3. According to embodiment presented in FIG. 3 all existing overlapping events are listed 301 in a column, one below another. Overlapping events 301 can be displayed as a menu in a separate window 300 opening on a display after overlapping events are found. Next to listed overlapping events 301 there are typically selection columns as presented in FIG. 3 for silencing 303 or removing 302 listed overlapping events 301. Here the removal is a choice in a first column 302 and the silencing is a choice in a second column 303. From this presented menu 300 the user can select simply by crossing the corresponding alternatives which overlapping events he wants to remove away from a view of his calendar 302 and which overlapping events he wants to keep in his calendar and only silence 303. There is also presented, as a last alternative in the event column 301, a selection “All” 304, which corresponds with all listed overlapping events. This selection 304 makes it fast and easy to e.g. remove or silence all found overlapping events by simply crossing one box. This is effective, when there is no need to check the overlapping events individually. The menu presented in FIG. 3 is one example of presentation and does not limit a form or presentation of overlapping events to this specific implementation.

The embodiments presented in FIGS. 1 and 2 can also be combined so that first, after a high priority event is received, steps 202-204 of FIG. 2 are performed, i.e. found overlapping events are listed and presented to a user on a menu with alternatives for processing overlapping events. The user may then select from listed events the ones that are to be silenced or removed according to the embodiment of FIG. 2. After the user has selected certain events and their processing there might still be some unprocessed overlapping events. For these still unprocessed overlapping events, the steps 102-105 of the embodiment of FIG. 1 are performed. This way remaining overlapping events, i.e. the events not removed or silenced at the embodiment according to steps of FIG. 2, are pointed out individually. The user may then process also these remaining overlapping events one by one according to the embodiment of FIG. 1, or choose to leave some overlapping events untouched and unprocessed, as they are.

Typically overlapping events that the user chooses to remove from his calendar are stored to some determined place. According to an embodiment after new high priority event is added to a calendar application, there is presented to the user all events he has removed or silenced. The user is then able to check and reschedule the removed events at this phase. New times or timetables can be given to the presented removed events at this time. If no new time is scheduled for certain removed event, it may be deleted or stored to a certain memory block for some determined time.

FIG. 4 illustrates a device for browsing a calendar application according to an embodiment of the present invention. A device used can be for example a personal computer (PC), a laptop, a terminal of a network, a personal digital assistant (PDA), a mobile device, a mobile telephone, or any other device capable of browsing a calendar application according to an embodiment of the invention. Typically such a device comprises a control unit 401 for controlling all components, blocks and commands of a device. A control unit 401 takes care of and controls all functions and executions performed by the device. The control unit 401 also controls all other drivers and controllers.

The device illustrated in FIG. 4 comprises a display 402 for displaying data to a user. According to an embodiment a display 402 can further be employed as an input block. For example in some devices a touch screen layer can be superimposed on a display 402 enabling a data input through the display 402. There is presented a keyboard 406 as an input means. There might as well be another input means, such as a mouse, a light pen, and a microphone for a voice input, or another kind of means for inputting data to a device.

A connection unit 405 in a device is a counterpart for a fixed connection, which can be implemented by a cable or other such means. A connection unit 405 is optional in a device. The device illustrated in FIG. 4 can be for example a terminal, which connection unit 405 is connected to a server through a fixed line. In one embodiment a calendar application 407 and program component 408 as well as other components or units can be situated at a remote server and be accessed and used by a device through a fixed connection 405. Another example of a device connected by a fixed connection 405 is a computer, which is power supplied by a fixed cable. According to an embodiment a device also, or instead, has means for wireless connection 404. A wireless connection 404 can be a short distance connection, which is typically implemented by infrared- or a short range radio technology such as standardized under the Bluetooth™ Standard. According to another embodiment a wireless connection 404 is established through a radio network for example. Such a used network is accessed through an antenna of a device. Typically a device comprises a transmission- and a reception branches (not illustrated in FIG. 4), which take care of transceiving functions to and from such a network.

A memory 403 is used for storing information. The stored information can be data chosen by a user, data relating to components or blocks of the device or functioning of those, or any data needed, or to be used later. A memory 403 can comprise volatile and non-volatile parts and different kind of memory blocks in order to use a memory 403 effectively. The memory 403 can have different memory structures suitable for used applications and implementations. A memory 403 can have allocated blocks for certain applications or uses, or a memory 403 can comprise several individual memory blocks.

A device illustrated in FIG. 4 further comprises a calendar application 407. The user can input data to calendar application 407 by input means, such as keyboard 406. Inputted data enters through a control unit 401. Data of a calendar application 407 can be presented in a display 402. A control unit 401 also controls presentation. A data stored for, used by and fed in a calendar application 407 can be stored to a common memory 403 of a device. Typically there is a certain allocated area in memory 403 for use of a calendar application. According to one embodiment a calendar application 407 has its own dedicated memory block used only by this application. According to an embodiment it is possible to remotely access a calendar application 407 through a fixed connection 405, or through a wireless connection 404, which can be implemented for example according to a wireless application protocol (wap). According to this embodiment a device illustrated in FIG. 4 comprises, besides a connection, a browser for browsing a remote calendar application.

According to another embodiment of the present invention there is further supplied a program component 408. A program component 408 is used to perform steps according to an embodiment of the invention, when a high priority event has occurred. A high priority event can be formed and thus inputted by a user. Another typical case is that a high priority event is received from another device through a fixed connection 405 or through a wireless connection 404. Whatever way a high priority event is received, it can be recognized to be a high priority event according to an embodiment of the invention in a control unit 401. A control unit can then command a program component 408 to execute for searching possible overlapping events and processing found ones in a predetermined way. This execution uses the calendar application 407 and the information stored in a memory 403 to find all possible overlapping events and their time information. Needed information can be fetched straight from the calendar application 407, or through a control unit 401. Accordingly information stored in a memory 403 can be accessed. Found overlapping events are associated with processing alternatives and those are presented to user in a display 402. In response to instructions inputted by a user, overlapping events are processed by a program component 408 according to received instructions. After user confirmation, performed actions are communicated to the calendar application.

According to one embodiment a control unit 401 starts a calendar application 407 in response to receiving an event. A high priority event is recognized by a calendar application 407. As a response to recognizing a high priority event a calendar application 407 transmits it to a program component 408, which is then executed according to a received high priority event, especially a time information included in it. A high priority event can be processed as described earlier in this description. The overlapping events removed or deleted according to an embodiment of the present invention, can be stored in common memory 403, or to a dedicated memory block of a calendar application 407 or a program component 408 (not shown in a FIG. 4). By storing removed or deleted overlapping events, they can be recovered in case of a cancellation of the added high priority event, or other possible changes in calendar. Typically a user may select, which formerly removed events he wishes to restore and which formerly silenced he wishes to unsilence in case of a later removal of the added high priority event. Advantageously removed or deleted events can be checked, rescheduled or reviewed later on. Storing makes later processing of events possible.

It will therefore be evident that the steps shown in FIGS. 1 and 2 will be encoded according to a selected programming language or equivalently embedded in hardware logic in combination with memory devices, input/output ports, a central processing unit, and interconnecting data, address and control busses so as to comprise means necessary to carry out these steps. These steps may therefore in some embodiments comprise software means for carrying the functions of the described steps.

1. A device for handling a calendar application, comprising
means for browsing a calendar application,
means for receiving a high priority event to be added to a calendar application,
means for searching possible overlapping events in a calendar application as a response to receiving a high priority event,
means for presenting found one or more overlapping events,
means for receiving instructions for processing certain one or more presented overlapping events, and
means for processing overlapping events according to received instructions.

2. A device according to claim 1, comprising a program component for searching possible overlapping events.

3. A device according to claim 1, comprising means for associating processing alternatives with found overlapping events.

4. A device according to claim 1, comprising means for presenting to user found one or more overlapping events with one or more selectable processing alternatives associated to those.

5. A device according to claim 1, comprising a program component for processing found overlapping events according to received processing instructions.

6. A device according to claim 1, wherein a high priority event is selectable from a menu of a calendar application.

7. A device according to claim 1, comprising means for searching a memory block storing removed overlapping calendar events as a response to deleting the high priority event from the calendar application, and recovering found, timely matching, previously removed, overlapping events to the calendar application.

8. A device according to claim 1, comprising means for comparing time associated to a high priority event to a respective time of a calendar application for finding possible overlapping events from the calendar application.

9. A device according to claim 1, wherein a calendar application is situated in a device using it.

10. A device according to claim 1, wherein a calendar application is situated in a remote device being connected to a device using the calendar application.

11. A device according to claim 1, wherein the received high priority event is recognized by a central unit of a device.

12. A device according to claim 1, wherein the received high priority event is recognized by a calendar application.

13. A method for handling a calendar application, comprising steps of:
receiving a high priority event to be added to a calendar application,
searching possible overlapping events in a calendar application as a response to receiving a high priority event,
when one or more overlapping events are found, presenting found one or more overlapping events with one or more processing alternatives for processing the found events,
receiving a processing instruction for one or more presented overlapping events, and
processing the one or more overlapping events according to the one or more received processing instructions.

14. A method according to claim 13, comprising a step of adding the received high priority event to the calendar application and processing the one or more overlapping events according to the one or more received processing instructions as a response to a confirmation by a user.

15. A program for handling a calendar application, comprising
software means for browsing a calendar application,
software means for receiving a high priority event,
software means for searching possible overlapping events in a calendar application as a response to receiving a high priority event,
software means for associating found one or more overlapping events with one or more processing alternatives, and
software means for receiving selected alternatives as instructions for processing certain one or more presented overlapping events, and
software means for processing overlapping events according to received instructions.

16. A program component for handling a high priority event comprising
means for starting a search for possible overlapping events in a calendar application as a response to receiving a high priority event,
means for associating the found one or more overlapping events with one or more alternatives for processing those, and
means for processing presented overlapping events according to received selections for processing alternatives.
